(19) United States
(12) Patent Application Publication
(10) Pub. No.: US 2026/0148255 A1
(43) Pub. Date: May 28, 2026

(54) TOKENIZED ENERGY MANAGEMENT

(71) Applicant: QSecGrid, Inc., New York, NY (US)

(72) Inventors: Gordon R. WINSTON, Katonah, NY (US); John-Philip GALINSKI, Forest Hills, NY (US); Nigel WALKER, Ponteland (GB); Mark THOMPSON, Blyth (GB); Patrick J.D. SANTOS, Kirkland, WA (US)

(21) Appl. No.: 19/274,163

(22) Filed: Jul. 18, 2025

Related U.S. Application Data
(60) Provisional application No. 63/725,419, filed on Nov. 26, 2024.

(51) Int. Cl. G06Q 30/0201; H04L 9/32

(52) U.S. Cl. CPC G06Q 30/0206; H04L 9/3213

(57) ABSTRACT

An energy management system may include a tokenization platform coupled with at least one energy accounting system. The energy management system may include at least one transaction monitor that may be configured to fetch transaction trace data, from the at least one energy accounting system, for executing at least one energy-related transaction between at least one first entity and at least one second entity. The at least one transaction monitor may further be configured to perform transaction reconciliation for the at least one first entity and the at least one second entity based on the fetched transaction trace data. The energy management system may include at least one token manager that may be configured to orchestrate one or more energy-backed tokens based on the transaction reconciliation for the first entity and the second entity.

### RELATED APPLICATION

This application claims priority to a commonly owned, U.S. Provisional Ser. No. 63/725,419 , filed on Nov. 26, 2024, and titled “Tokenized Energy Distribution”, which is herein incorporated by reference in its entirety.

### TECHNICAL FIELD

Embodiments of the present invention generally relate to managing energies, and more particularly to energy management utilizing tokens.

### BACKGROUND

Energy is a fundamental resource that powers economies, industries, and daily life. Traditionally, electrical power has been generated through centralized power plants and transmitted via extensive networks to end users. However, as energy demand continues to grow and environmental concerns increase, the focus is shifting towards more sustainable and decentralized methods of energy generation. This shift is primarily driven by the adoption of renewable energy sources such as solar, wind, and hydropower, which offer the potential for cleaner, more efficient, and localized energy production.

The energy sector faces a persistent challenge of limited transparency in energy transactions. Traditional energy systems often obscure critical details, such as a source of energy generation, transaction pathways, and pricing structures. This lack of visibility can create inefficiencies, mistrust, and disputes between stakeholders, including producers, consumers, and regulators. Furthermore, the absence of real-time tracking and verification mechanisms complicates accountability and hinders compliance with sustainability standards. These issues may be more pronounced in distributed energy systems, where multiple participants make transparency even more complex.

There is thus a need for more efficient and/or effective energy management.

### BRIEF DESCRIPTION OF THE DRAWINGS

Features and advantages of embodiments of the present invention will become apparent upon consideration of the following detailed description of embodiments thereof, especially when taken in conjunction with the accompanying drawings, in which:

FIG. 1 is a block diagram depicting an exemplary computing environment for tokenized energy management in accordance with at least one embodiment of the present invention.

FIG. 2 is an exemplary functional block diagram of components of an energy management system in accordance with at least one embodiment of the present invention.

FIG. 3 is an exemplary illustration of a decentralized network of an energy management system in accordance with at least one embodiment of the present invention.

FIG. 4 is an exemplary process of token orchestration in accordance with at least one embodiment of the present invention.

FIG. 5 is an exemplary process of token life-cycle management in accordance with at least one embodiment of the present invention.

FIG. 6 is an exemplary process of decentralized trading of energies in accordance with at least one embodiment of the present invention.

FIG. 7 is an exemplary process of report generation in accordance with at least one embodiment of the present invention.

FIG. 8 a schematic diagram illustrating aspects of an example computer in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

An energy management system may include a tokenization platform communicatively coupled with at least one energy accounting system, which may include at least one transaction monitor. The at least one transaction monitor may be configured to at least fetch transaction trace data, from the at least one energy accounting system, for executing at least one energy-related transaction between at least one first entity and at least one second entity. The at least one transaction monitor may further be configured to perform transaction reconciliation for the at least one first entity and the at least one second entity based on the fetched transaction trace data. The energy management system may further include at least one token manager configured to at least orchestrate one or more energy-backed tokens based on the transaction reconciliation for the at least one first entity and the at least one second entity.

A method for tokenized energy management may include fetching transaction trace data from at least one energy accounting system for executing at least one energy-related transaction between at least one first entity and at least one second entity. The method for tokenized energy management may further include performing transaction reconciliation for the at least one first entity and the at least one second entity based on the fetched transaction trace data. The method for tokenized energy management may further include orchestrating one or more energy-backed tokens for the at least one first entity and the at least one second entity based on the transaction reconciliation.

One or more computer-readable media, collectively storing instructions that, when executed by one or more processors, collectively cause one or more computing devices to at least fetch transaction trace data from at least one energy accounting system for executing at least one energy-related transaction between at least one first entity and at least one second entity. Further, the non-transitory computer-readable medium (CRM) may cause the computing device to perform transaction reconciliation for the at least one first entity and the at least one second entity based on the fetched transaction trace data. The non-transitory computer-readable medium (CRM) may cause the computing device to orchestrate one or more energy-backed tokens for the at least one first entity and the at least one second entity based on the transaction reconciliation.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input may be received before performance of the process or operation. Human input may be deemed to be material if such input influences how the process or operation will be performed. Human input that consents to the performance of the process or operation may not be deemed to be “material.”

The term “determine” and variations thereof, as used herein, may include any suitable type of methodology, process, operation, and/or technique. Such determinations may include calculations and/or computations.

The term “distributed energy network” and variations thereof, as used herein, may be defined as a collection of interconnected energy sources, energy storage facilities, energy consumers and/or consumption points, that may be working individually or collaboratively to produce, store, manage, consume and/or distribute energy across one or more locations.

The term “microgrid” and variations thereof, as used herein, may be defined as a localized, partially or fully self-sufficient energy system that may operate autonomously or in connection with a larger utility grid. A microgrid may encompass various energy generation, storage, management, distribution and/or consumption components, which may include renewable and non-renewable energy sources, energy storage systems, and/or diverse end-users or consumers of energy.

The term “Integrated Distributed Energy Resources” (IDERs) and variations thereof, as used herein, may be defined as energy generation, storage, and/or consumption units that are interconnected within a distributed energy network and capable of being integrated into a centralized or decentralized energy management system. IDERs may be characterized by their ability to generate, store, and/or consume energy locally, and their compatibility with communication and control frameworks for real-time monitoring, management, and/or optimization of energy production, storage, and/or consumption within a microgrid or similar energy distribution network.

The term “energy source” and variations thereof, as used herein, may be defined as an entity or mechanism capable of and/or responsible for generating and/or supplying energy within a distributed energy network. A set of energy sources may form a subset of Integrated Distributed Energy Resources (IDERs) and may include renewable energy sources such as solar panels, wind turbines, and hydroelectric plants, as well as non-renewable energy sources such as fossil fuel-based generators and nuclear power plants, and energy storage devices and facilities such as batteries.

The term “energy consumer” and variations thereof, as used herein, may be defined as an entity, machine, device or mechanism that consumes and/or dissipates energy. Energy consumers may include one or more energy-associated machines and may correspond to IDERs. At times, the term energy consumer may be used to refer to a responsible person or entity that utilizes or draws energy from the one or more energy-associated machines. Examples of such energy consumers include an individual, a business, a utility company, or a grid operator. The one or more energy consumers may be associated with one or more energy profiles.

The term “energy storage facilities” and variations thereof, as used herein, may be defined as infrastructure, systems, and/or energy-associated machines and/or devices capable of storing energy. As a subset of Integrated Distributed Energy Resources (IDERs), the energy storage facilities may be integral to distributed energy networks and may function both as energy consumers and energy sources. The energy storage facilities may dynamically shift roles based on energy demands, supply conditions, grid requirements, and/or operational priorities.

The term “energy management system user” and variations thereof, as used herein, may be defined as a person or an entity that engages with energy management systems. The energy management system user may perform functions such as viewing, managing, and/or analyzing energy transactions, generating reports, and/or facilitating energy trading. The energy management system user may further be enabled to perform functions such as administering, adding, removing, and/or configuring the one or more IDERs. The energy management system user may further be enabled to interact with the energy management systems through a user interface, and the interactions may be logged for audit and compliance purposes.

The term “energy management system administrator” and variations thereof, as used herein, may be defined as a person or an entity that may have advanced access rights within the energy management systems. The energy management system administrator may be responsible for tasks such as configuring system settings, managing user accounts and permissions, enabling data integrity, overseeing compliance with regulatory requirements, and maintaining overall system security. The energy management system administrator may have an ability to audit transactions, modify system parameters, and troubleshoot technical issues. The actions performed by the energy management system administrator may be logged in the energy management systems for tracking and compliance purposes.

The term “energies” and variations thereof, as used herein, may be defined as various forms of energy, including electrical energy generated from renewable and non-renewable energy sources. The energies may be categorized based on their provenance of generation, such as solar, wind, hydro, fossil fuel, or nuclear, and may be tracked, managed, and traded with the energy management systems.

The term “energy allocation” and variations thereof, as used herein, refer to a process of distributing energy resources across a network or system, for example, based on demand, availability, and/or operational priorities. The energy allocation may involve dynamic adjustments to enable efficient resource utilization, grid stability, and/or demand-response management. Within an energy management framework, the energy allocation may be done by considering telemetry data, energy-related attributes, and/or real-time grid conditions to prioritize and allocate energy to various resources, including generation, storage, and/or consumption units, for seamless integration and optimized performance within microgrid environments.

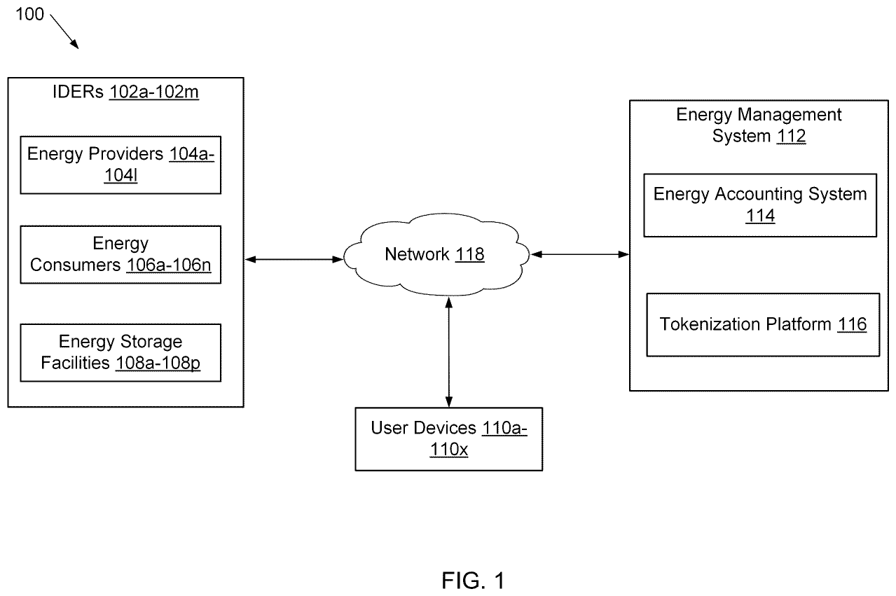

FIG. 1 depicts an exemplary computing environment 100 within distributed energy networks, according to at least one embodiment of the present invention. The computing environment 100 may be configured to enable an integration of a plurality of Integrated Distributed Energy Resources (IDERs) 102a-102m within the distributed energy networks.

In an embodiment of the present invention, the plurality of IDERs 102a-102m (hereinafter also referred to as “IDER 102” or “IDERs 102”) may include various energy generation, energy storage, and/or energy distribution systems. The IDERs 102 may further be associated with one or more of one or more energy providers 104a-104l (hereinafter also referred to as “energy provider 104” or “energy providers 104”), one or more energy consumers 106a-106n (hereinafter also referred to as “energy consumer 106” or “energy consumers 106”), and one or more energy storage facilities 108a-108p (hereinafter also referred to as “energy storage facility 108” or “energy storage facilities 108”).

The one or more energy providers 104 may be, for example, traditional power generation plants such as coal-fired, gas-fired, or nuclear power plants, renewable energy sources such as solar farms, wind farms, hydropower plants, and geothermal energy plants, Distributed Energy Resources (DERs) such as rooftop solar panels and small-scale wind turbines, biomass and waste-to-energy facilities, energy storage facilities such as battery storage plants, fuel cell-based energy generation systems, hydrogen power plants, cogeneration or Combined Heat And Power (CHP) units, microgrid operators providing localized energy production, utility companies acting as intermediaries for power distribution, virtual power plants aggregating energy from multiple small-scale sources, tidal and wave energy plants, synthetic fuel-based power plants, energy cooperatives managing shared renewable energy projects, Electric Vehicle-to-Grid (V2G) systems supplying stored energy from EVs, nuclear fusion pilot plants (as emerging technology), and experimental energy sources, such as kinetic or thermoelectric generators.

The energy providers 104 may also include human-powered energy generation systems, such as pedal-powered generators, hand-crank generators, energy harvested from human movement using wearable devices or pressure-sensitive flooring, and so forth. The energy providers 104 may also include energy brokers, energy storage systems, and microgrid operators that may produce, store, or redistribute energy, in another embodiment of the present invention. Additionally, the energy providers 104 may include one or more energy providing entities that may participate in energy lending, energy borrowing, or trading markets. Embodiments of the present invention may be intended to include or otherwise cover any suitable energy providers 104. The energy providers 104 may be owned and/or managed by the one or more energy providing entities such as residential energy management system users, commercial establishments, industrial facilities, and so forth, in an embodiment of the present invention.

The energy consumers 106 may be one or more energy-associated machines and/or devices. The one or more energy-associated machines and/or devices may be, for example, heat pumps, Heating, Ventilation, and Air Conditioning (HVAC) systems, electrical appliances such as, refrigerators, washing machines, dishwashers, ovens, and microwaves, generators, electric vehicles, battery storage systems, lighting systems such as LED lights, streetlights, and emergency lighting, air conditioners, water heaters, industrial machinery, such as conveyor belts, pumps, and compressors, automated manufacturing equipment, data centers, computers, mobile phones, smart gadgets, servers, processors, smart home devices, such as, thermostats, smart plugs, and security systems, agricultural equipment, such as irrigation pumps and greenhouse climate control systems, electric forklifts, electric-powered construction tools, electric motors in various applications, medical devices such as oxygen machines, ventilators, diagnostic imaging equipment (e.g., MRI and CT scanners), infusion pumps, patient monitoring systems, and other critical healthcare infrastructure powered by electrical systems and so forth. Embodiments of the present invention may be intended to include or otherwise cover any suitable type of the energy-associated machines and/or devices, including known, related art, and/or later developed technologies. The energy consumers 106 may also include the energy brokers, the energy storage systems, and the microgrid operators that may consume, store, or redistribute energy, in another embodiment of the present invention. Embodiments of the present invention may be intended to include or otherwise cover any suitable energy consumers 106.

The energy consumers 106 may be owned and/or managed by one or more energy consuming entities such as the residential energy management system users, the commercial establishments, the industrial facilities, electric vehicle charging stations, healthcare facilities, industries, utility companies, and so forth, in an embodiment of the present invention. Additionally, the one or more energy consuming entities may participate in energy lending, energy borrowing, or trading markets, as well as those who may seek to optimize their energy usage based on sustainability goals, in yet another embodiment of the present invention.

In an embodiment of the present invention, the energy storage facilities 108 may be, for example, battery storage systems, pumped hydro storage facilities, flywheels, Compressed Air Energy Storage (CAES), thermal storage units, supercapacitors, gravity-based storage systems, hydrogen-based storage, Liquid Air Energy Storage (LAES), electrochemical storage, thermochemical energy storage, synthetic fuel storage, cryogenic energy storage, and so forth. Embodiments of the present invention may be intended to include or otherwise cover any suitable type of the energy storage facilities 108, including known, related art, and/or later developed technologies.

According to the embodiments of the present invention, the energy storage facilities 108 may be configured to operate dynamically as either the energy providers 104 or the energy consumers 106 based on real-time demand and supply conditions within the computing environment 100. For example, when energy supply exceeds demand, the energy storage facilities 108 may operate as the energy consumers 106 by storing surplus energy. Conversely, during periods of high demand or limited supply, the energy storage facilities 108 may act as energy providers 104 by discharging stored energy back to a grid or to the one or more energy consumers 106. The energy storage facilities 108 may be owned and/or managed by one or more energy storing entities.

In an embodiment of the present invention, the one or more energy providing entities associated with the energy providers 104, the one or more energy consuming entities associated with the energy consumers 106, and/or the one or more energy consuming entities associated with the energy storage facilities 108 may be referred commonly as ‘the entities’ or ‘the entity’.

According to at least one embodiment of the present invention, the one or more entities may have one or more user devices 110a-110x (hereinafter also referred to as the user devices 110 or the user device 110). The user devices 110 may enable the energy consumers 106 to interact within the computing environment 100. The user devices 110 may be for example smartphones, tablets, laptops, desktop computers, displays, screens, smart watches, smart speakers, smart thermostats, Internet-of-Things (IoT)-enabled devices, and so forth. Embodiments of the present invention may be intended to include or otherwise cover any suitable type of user device 110, including known, related art, and/or later developed technologies.

The user devices 110 may enable the one or more entities and/or the energy management system users to access and interact with an energy management system 112 within the computing environment 100, according to at least one embodiment of the present invention. Further, the user devices 110 may enable the one or more entities to initiate, stop, monitor, regulate, and optimize energy allocations through the energy management system 112. The user devices 110 may further facilitate communication among the one or more entities and the computing environment 100 to enable real-time energy management and control. The user devices 110 may include a user interface (not shown) for easy communication and interaction with the energy management system 112.

The energy management system 112 may be configured to facilitate seamless integration of Distributed Energy Resources (DERs) within the distributed network. According to at least one embodiment of the present invention, the energy management system 112 may include an energy accounting system 114, and a tokenization platform 116.

According to at least one embodiment of the present invention, the energy accounting system 114 may be configured to track, record and/or organize energy-related transactions between the one or more entities. The energy accounting system 114 may be configured to fetch transaction trace data, and/or log reconciliation data for maintaining accountancy of the energy-related transactions.

According to at least one embodiment of the present invention, the tokenization platform 116 may be configured to orchestrate energy-backed tokens based on reconciled transactions. The tokenization platform 116 may further be configured to manage token issuance, burning, and/or minting for decentralized energy trading of the energies. The tokens may be cryptographic tokens, and token management operations such as issuance, verification, burning, generation and/or minting may involve cryptographic operations. Orchestration of energy-backed tokens may include any suitable token management operation, for example, issuance, verification, burning, generation and/or minting, as well as management with respect to token collections, token owners, token types, token numbers (total and by type), and/or token accounts.

Further, the computing environment 100 may include a network 118. According to the embodiments of the present invention, the network 118 may enable communication and data exchange across various energy management system users, participants, and components of the computing environment 100. The network 118 may include a data network such as the Internet, Local Area Network (LAN), Wide Area Network (WAN), Metropolitan Area Network (MAN), etc. In certain embodiments of the present invention, the network 118 may include a wireless network, such as, a cellular network, and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS), and so forth. In some embodiments of the present invention, the network 118 may include or otherwise cover networks or sub-networks, one or more of which may include, for example, a wired or wireless data pathway. The network 118 may include a circuit-switched voice network, a packet-switched data network, or any other network capable of carrying electronic communications. For example, the network 118 may include networks based on the Internet Protocol (IP) or Asynchronous Transfer Mode (ATM) and may support voice usage, for example, VoIP, Voice-over-ATM, or other comparable protocols used for voice data communications.

Examples of the network 118 may further include a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments of the present invention may be intended to include or otherwise cover any type of the network 118, including known, related art, and/or later developed technologies.

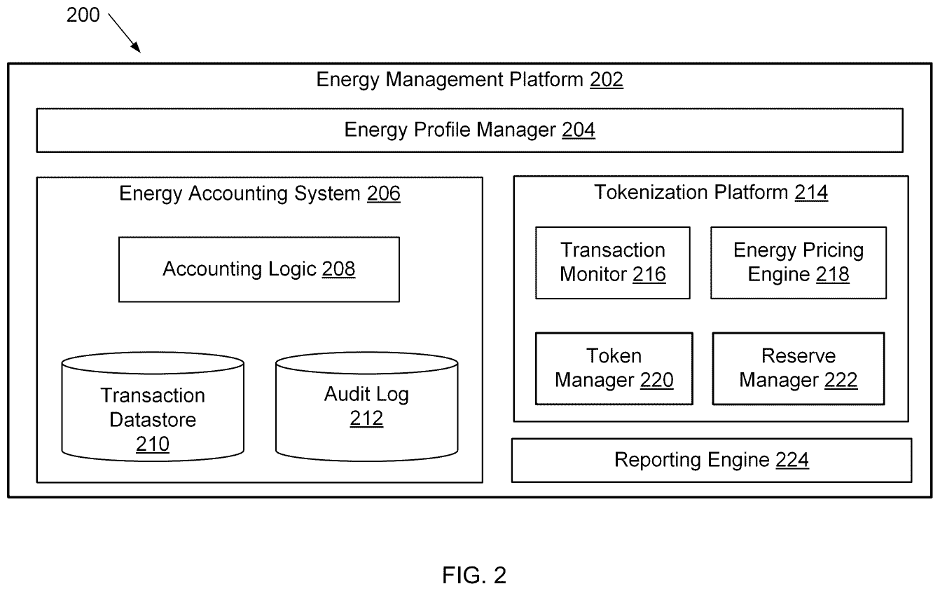

FIG. 2 depicts an energy management system 200, according to at least one embodiment of the present invention. The energy management system 200 (FIG. 2) may be an example of the energy management system 112 (FIG. 1). The energy management system 200 may include an energy management platform 202.

In an embodiment of the present invention, the energy management platform 202 may be a software application stored in a server (not shown). In another embodiment of the present invention, the energy management platform 202 may be implemented as a hardware, a firmware, a software, or a combination thereof, that may be managed by a third-party service provider. According to the embodiments of the present invention, the energy management platform 202 may be configured to enable the energy-related transactions among the one or more entities.

The energy management platform 202 may include an energy profile manager 204, and an energy accounting system 206.

According to at least one embodiment of the present invention, the energy profile manager 204 may be configured to generate one or more user profiles based on personal information received from the one or more entities. The energy profile manager 204 may be further configured to generate one or more energy profiles for the one or more entities based on information received from the one or more entities.

The received information may include, for example, historical energy consumption data, projected energy requirements, operational schedules, geographic location, type of energy sources used, environmental conditions, one or more business rules, real-time energy allocation requirements, energy generation data, energy storage capacity, real-time energy availability, energy transmission losses, demand-side management metrics, peak demand patterns, maintenance schedules, energy efficiency ratings of equipment, carbon emission targets, energy cost parameters, renewable energy contribution ratios, grid stability parameters, weather forecasts, market energy price fluctuations, load balancing requirements, safety protocols, cybersecurity considerations for energy systems, feedback from previous energy allocation decisions, contractual agreements with energy providers, financial budgets for energy procurement, audit logs of energy usage, regulatory or compliance requirements applicable to the respective entities, and so forth. Embodiments are intended to include or otherwise cover any suitable type of the information, including known, related art, and/or later developed technologies.

According to at least one embodiment of the present invention, the energy accounting system 206 may include an accounting logic 208. The energy accounting system 206 may be configured to log and/or organize the energy-related transactions based on the accounting logic 208. The accounting logic 208 may be configured to apply predefined rules and/or algorithms for categorizing, classifying, and/or evaluating the energy-related transactions. The accounting logic 208 may be configured to enable a traceability of the energy-related transactions by indexing the energy-related transactions based on energy-related attributes such as an energy type, a provenance, a chain of custody, an allocation criteria, and so forth.

According to at least one embodiment of the present invention, the energy accounting system 206 may include a transaction datastore 210. According to at least one embodiment of the present invention, the transaction datastore 210 may be configured to store the transaction trace data. The transaction trace data may be transaction metadata associated with an initiated energy-related transaction.

The transaction trace data may include, for example, transaction initiation timestamps, unique transaction identifiers, identities of the involved entities (i.e., the energy providers, the energy consumers, and the energy intermediaries), energy quantity requested, provisional pricing, energy type (i.e., renewable or non-renewable), a specified energy source, transaction method (i.e., direct purchase, peer-to-peer trading, or auction), contractual terms, transmission path, expected settlement time, regulatory compliance status, certification details, carbon impact assessment, applicable fees or taxes, predefined conditions associated with the transaction, and so forth. The transaction trace data may enable real-time monitoring, validation, and reconciliation of the transaction before final settlement of the transaction between the one or more entities.

According to at least one embodiment of the present invention, the transaction datastore 210 may be, for example, a cloud database, a distributed database, a personal database, an end-user database, a commercial database, a Structured Query Language (SQL) database, a non-SQL database, an operational database, a relational database, an object-oriented database, a graph database, and so forth. Embodiments of the present invention may be intended to include or otherwise cover any suitable type of the transaction datastore 210 including known, related art, and/or later developed technologies.

Further, the transaction datastore 210 may be stored in a cloud server, in an embodiment of the present invention. In an embodiment of the present invention, the cloud server may be remotely located. In an exemplary embodiment of the present invention, the cloud server may be a public cloud server. In another exemplary embodiment of the present invention, the cloud server may be a private cloud server. In yet another embodiment of the present invention, the cloud server may be a dedicated cloud server. According to embodiments of the present invention, the cloud server may be a Microsoft Azure cloud server, an Amazon AWS cloud server, a Google Compute Engine (GCE) cloud server, an Amazon Elastic Compute Cloud (EC2) cloud server, and so forth. Embodiments of the present invention may be intended to include or otherwise cover any suitable type of the cloud server including known, related art, and/or later developed technologies.

According to at least one embodiment of the present invention, the energy accounting system 206 may be configured to log the energy-related transactions upon execution and/or reconciliation in an audit log 212. The audit log 212 may be a structured format or a database that may be configured to organize the logged energy-related transactions related to the one or more energies that may be transmitted, received, aggregated, reaggregated and/or disaggregated among the one or more entities. The audit log 212 may be configured to organize historical energy-related transactions, real-time energy-related transactions, futuristic energy-related transactions related to the energies, and so forth. Embodiments of the present invention may be intended to include or otherwise cover any suitable energy-related transactions including known, related art, and/or later developed technologies.

As discussed above, the energy-related transactions may include information, such as, the energy source, the energy consumer, the type of energy (i.e., renewable or non-renewable), the provenance of energy, the energy quantity requested, a value of energy, and the energy efficiency rating, an energy source type, a certification status, the provenance, a carbon impact, a date, a time, and so forth. Embodiments of the present invention may be intended to include or otherwise cover any suitable information for the energy-related transactions including known, related art, and/or later developed technologies. The information related to the energy-related transactions logged in the audit log 212 may be accounted for in form of debits and credits.

According to at least one embodiment of the present invention, the audit log 212 may be adapted to record and maintain the mapping of all energy-related transactions. The audit log 212 may be adapted to store detailed entries for energy generation, consumption, and transfer activities, ensuring accuracy and traceability. By utilizing double-entry bookkeeping principles, the audit log 212 may enable reconciliation, compliance, and financial reporting for energy operations. The audit log 212 may be adapted to record energy data including energy-related transactions and/or associated metadata. The audit log 212 may further be adapted to record energy provenance data such as a type of energy, a source of energy, a destination of energy, energy attributes such as a green energy classification, a brown energy classification, a grey energy classification, and so forth. Embodiments of the present invention may be intended to include or otherwise record any suitable energy data including known, related art, and/or later developed technologies.

The audit log 212 may further be configured to maintain a chain of custody for the energy-related transactions. The audit log 212 may further be configured to maintain a chain of custody for the energy-related transactions that may be performed through the energy-backed tokens, and/or digital currency. The chain of custody may include a chronological record of energy flow, documenting the origin, intermediate steps, and final allocation of energy within the data center. For instance, the audit log 212 may track energy sourced from renewable energy sources like solar panels or wind turbines, its intermediate storage in batteries or other energy storage devices, and/or its subsequent distribution to the one or more server components and/or the one or more virtual machines. The chain of custody maintained by the audit log 212 may enable a traceability of energy-related transactions for compliance purposes, validation of energy usage claims, auditing of energy transactions, and/or verification of adherence to regulatory and net metering standards.

According to at least one embodiment of the present invention, the energy management system 200 may further include a tokenization platform 214. The tokenization platform 214 may be adapted for creation, management, and/or trading of the energy-backed tokens. The tokenization platform 214 may be configured to enable a tracking of the energy-backed tokens, according to at least one embodiment of the present invention. The tracking may be performed by accessing the tokenization platform 214 through the user interface of the user device (e.g., the user device 110). The tracking of the energy-backed tokens may include functions such as viewing, managing, and/or analyzing energy-backed token transactions, generating and/or visualizing reports related to token balances and/or associated energy flows, monitoring real-time token performance metrics, checking and/or alerting on anomalies in transactions of the energy-backed tokens, setting alerts for price-trend, demand trends, and/or transaction favorability of the energy-backed tokens, raising grievances for discrepancies between recorded token amounts and actual energy data, auditing historical token transaction logs, performing predictive analytics for future token trends, customization of visualizations of token data, checking specific to token issuance and trading, automating periodic diagnostics related to token performance, and so forth. Embodiments of the present invention may be intended to include or otherwise cover any suitable function related to the tracking of the energy-backed tokens including known, related art, and/or later developed technologies.

The tokenization platform 214 may include a transaction monitor 216, an energy pricing engine 218, a token manager 220, and a reserve manager 222.

According to at least one embodiment of the present invention, the transaction monitor 216 may be configured to fetch the transaction trace data from the energy accounting system 206 in real-time and/or at predefined intervals. The transaction monitor 216 may be configured to authenticate the fetched transaction trace data before executing the energy-related transactions between the one or more entities. The transaction monitor 216 may be configured to perform the authentication of the fetched transaction trace data by verifying digital signatures, cryptographic hashes, audit trails, and so forth. For example, when an energy supplier may initiate an energy-related transaction of surplus energy transfer to an energy consumer, the transaction monitor 216 may be configured to authenticate the fetched transaction trace data by verifying the digital signature of the supplier against a public key stored in a secure ledger.

The transaction monitor 216 may further be configured to perform transaction reconciliation at least in part by cross-referencing the transaction trace data with actual energy consumption and/or energy generation records to validate an alignment with predefined regulatory and/or contractual frameworks. The transaction reconciliation may further be performed by validating the debits and/or the credits of the energy-backed tokens and/or other trading means for the one or more entities.

Consider a situation where an ‘Entity A’ has surplus energy that may be traded with an ‘Entity B’. The ‘Entity A’, after reviewing its energy profile, may determine that it has an excess of 2 MWh of renewable energy that may be traded to optimize resource allocation using the energy management system 200. The ‘Entity A’ may initiate an energy-related transaction with the ‘Entity B’ to transfer this surplus energy. The energy management system 200 may be configured to track the initiated energy-related transaction by activating the transaction monitor 216. Upon activation, the transaction monitor 216 may be configured to retrieve a transaction trace data of both the entities from the transaction datastore 210. The transaction monitor 216 may be configured to verify the retrieved transaction trace data, including the volume of energy being traded, the price, the agreed-upon terms, and so forth. Upon verification, in case of any disparity in the transaction trace data of both the entities, the transaction monitor 216 may be configured to initiate a reconciliation process.

During the reconciliation process, the energy management system 200 may be configured to validate that the surplus energy of the ‘Entity A’ may be debited and the ‘Entity B’ may be credited with the 2 MWh. In case, if the surplus energy may be debited from the energy profile of the ‘Entity A’, but not credited to the energy profile of the ‘Entity B’. The transaction monitor 216 may be configured to reconcile the energy-related transaction. Further, once, the energy may be credited to the ‘Entity B’, the energy-backed tokens may be burned to reflect the energy debit from ‘Entity A’ and the corresponding credit to ‘Entity B’. Based on the transaction reconciliation, the energy accounting system 206 may be configured to update the audit log 212 and/or validate that the surplus energy of the ‘Entity A’ may be debited and the ‘Entity B’ may be credited with the 2 MWh.

According to at least one embodiment of the present invention, the energy pricing engine 218 may be configured to compute pricing inputs for the one or more orchestrated energy-backed tokens. The energy pricing engine 218 may be configured to analyze energy pricing dynamics of energy markets, for example, variations in wholesale electricity prices across different geographic locations, localized grid congestion, and seasonal demand fluctuations. The energy pricing engine 218 may further be configured to assess the impact of renewable energy sources, such as solar farms, wind power installations, and hydropower plants, considering factors like weather-dependent energy generation, capacity utilization rates, and grid integration challenges. Additionally, the energy pricing engine 218 may be configured to account for fossil fuel-based energy production, including coal, natural gas, and oil-based power generation, factoring in fuel price volatility, carbon emissions policies, and operational costs.

The energy pricing engine 218 may further be configured to dynamically adjust values of the one or more orchestrated energy-backed tokens based on factors, including market energy rates, supply-demand variations, carbon footprint assessments, external economic indicators, and so forth. Embodiments of the present invention may be intended to include or otherwise cover any suitable factors including known, related art, and/or later developed technologies for dynamically adjusting the values of the one or more orchestrated energy-backed tokens.

The energy pricing engine 218 may further facilitate real-time pricing updates and/or communicate the pricing updates to the token manager 220 for accurate valuation of the energy-backed tokens. The energy pricing engine 218 may be configured to employ a pricing mechanism that may incorporate artificial intelligence (AI)-based predictive modeling to enhance pricing efficiency and/or stability in the energy markets, according to at least one embodiment of the present invention.

Consider a scenario of the present invention in which the ‘Entity C’ and the ‘Entity D’ may be engaged in an energy-related transaction, and the pricing of the energy-backed tokens may need to be dynamically adjusted. In such a scenario, the energy pricing engine 218 may be configured to compute the pricing inputs for the energy-backed tokens based on several factors, such as real-time market energy rates, supply-demand fluctuations, carbon footprint assessments, external economic indicators like inflation or fuel prices, and so forth.

For instance, during periods of high demand and limited renewable energy supply, the energy pricing engine 218 may be configured to increase the token price to reflect a higher cost of procuring energy from non-renewable sources. Conversely, during times of surplus renewable energy or when the grid experiences a low demand, the energy pricing engine 218 may be configured to lower the token price to reflect more favorable energy conditions.

Furthermore, the energy pricing engine 218 may be configured to incorporate the AI-based predictive modeling to forecast energy price trends. For example, if the energy management system 200 may be configured to predict a potential energy supply shortage due to upcoming weather conditions, the energy pricing engine 218 may be configured to proactively adjust token prices to account for the forecasted shortage. These real-time adjustment may be configured to enable the token manager 220 to update the token price of the energy-backed tokens.

According to at least one embodiment of the present invention, the token manager 220 may be configured to execute operations related to the issuance, burning, and minting of the one or more orchestrated energy-backed tokens. The token manager 220 may be configured to fetch energy allocation data from the energy accounting system 206 to detect surplus and/or deficit energy states of the one or more entities. In decentralized energy trading scenarios, the token manager 220 may be configured to interact with a blockchain network to facilitate secure and transparent token transactions. The token manager 220 may further ensure compliance with regulatory frameworks by maintaining an immutable record of token-related activities and validating token exchanges against authenticated transaction trace data.

According to at least one embodiment of the present invention, the reserve manager 222 may be configured to maintain a liquidity for redemptions corresponding to the one or more orchestrated energy-backed tokens (e.g., an available pool of tokens). The reserve manager 222 may be configured to dynamically manage currency reserves by balancing token transactions against available fiat and/or cryptocurrency reserves. The reserve manager 222 may further be configured to optimize the liquidity by monitoring market fluctuations, adjusting reserve allocations, and implementing risk-mitigation strategies to prevent liquidity shortages.

The reserve manager 222 may be configured to assess transaction volumes and/or redemption patterns to determine the required liquidity levels in real time. Additionally, the reserve manager 222 may be configured to interact with decentralized finance (DeFi) protocols, centralized exchanges, and/or institutional liquidity providers to maintain adequate reserve backing for the energy-backed tokens.

The reserve manager 222 may further be configured to implement risk mitigation strategies by monitoring liquidity thresholds and performing automated reserve adjustments in response to fluctuations in demands of the energy-backed token. In addition, the reserve manager 222 may be configured to integrate with one or more external financial institutions to facilitate cross-border energy transactions by enabling conversions between the energy-backed tokens and the currency reserves.

The energy management system 200 may further include a reporting engine 224. According to at least one embodiment of the present invention, the reporting engine 224 may be configured to generate reports based on based on the transaction reconciliations performed by the transaction monitor 216. The reporting engine 224 may further be configured to generate the reports based on the orchestration of the energy-backed tokens by the token manager 220. The reporting engine 224 may further be configured to generate the reports based on the pricing and pricing dynamics of the energy-backed tokens as fetched from the energy pricing engine 218. Additionally, the reporting engine 224 may be configured to provide insights into transactions, energy usage, issuance of the energy-backed tokens, compliance with regulatory standards, and so forth. The reporting engine 224 may be configured to support transparency and accountability by delivering analytics and/or documentation tailored to needs of the one or more entities, such as regulators, investors, and/or energy market participants.

Further, the reporting engine 224 may be configured to enable the energy consumers to access the generated reports in a desired report format. The desired report format may be, a read-only text, a Microsoft Word document (Word), a Portable Document Format (PDF), an animated presentation, a video summary, an interactive chart, a display banner, a social media leaflet, a mobile application widget, an augmented reality (AR) visualization, a virtual reality (VR) simulation, a spreadsheet with editable data (e.g., Microsoft Excel), a cloud-based interactive dashboard, an infographic, a podcast or audio summary, a holographic projection, an energy usage map overlay, a timeline-based animation, a live-stream-able report, a QR code linked summary, an energy allocation badge or certificate, a secure email attachment, a printed booklet, a digital flipbook, a compliance certificate template, a technical white paper, a customizable report template, a gamified energy tracker interface, and so forth. Embodiments of the present invention may be intended to cover any suitable format, including known, related art, and/or later developed technologies for accessing the generated reports.

Consider a scenario where an ‘Entity E’ and an ‘Entity F’ may have completed a series of energy-related transactions involving an exchange of renewable energy-backed tokens. The transaction reconciliation process may be carried out by the transaction monitor 216, and the energy-backed tokens may have been issued and adjusted accordingly. In such a scenario of the present invention, the reporting engine 224 may be configured to generate the reports that may be configured to reflect a transaction lifecycle. For instance, the reporting engine 224 may be configured to generate a report summarizing the total energy exchanged between the ‘Entity E’ and the ‘Entity F’, including the amount of renewable energy traded, the associated prices per token, and any adjustments made based on market conditions. The generated report may further be configured to include a breakdown of the energy-backed token issuance and burning activities, detailing the number of tokens minted for the ‘Entity E’ and the number of tokens burned upon crediting the ‘Entity F’.

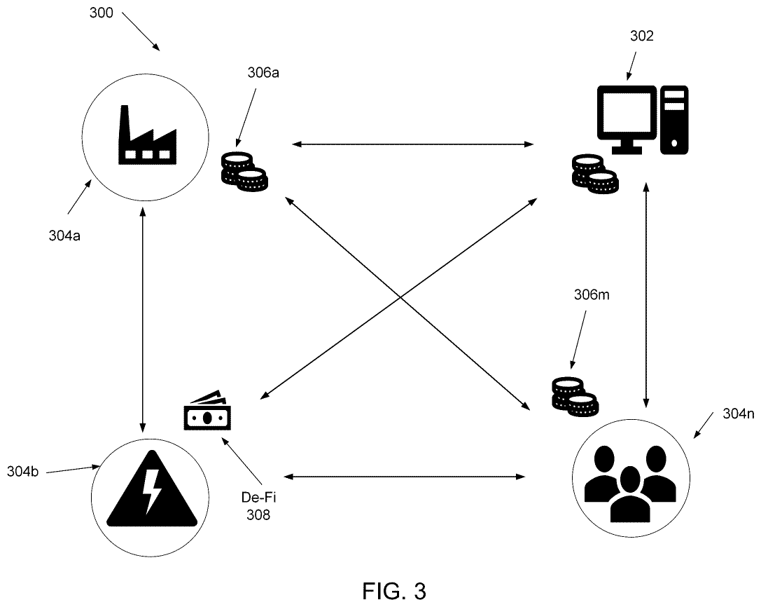

FIG. 3 depicts a decentralized network 300 of an energy management system 302 in accordance with at least one embodiment of the present invention. The decentralized network 300 may be configured to facilitate peer-to-peer energy trading by employing blockchain-based tokenization and/or smart contracts.

The decentralized network 300 may enable interaction among the energy management system 302 and one or more entities 304a-304n. The one or more entities 304a-304n may represent energy producers, consumers, grid operators, regulatory authorities, or financial institutions participating in energy transactions within the decentralized network 300. The interaction between the one or more entities 304a-304n may be governed by predefined protocols that may enable secure, transparent, and/or tamper-resistant energy trading. The decentralized network 300 may further include trading means such as energy-backed tokens 306a-306m and/or decentralized finance (DeFi) currency 308. The energy-backed tokens 306a-306m may serve as a digital representation of energy credits, that may allow the one or more entities 304a-304n to trade surplus energy in exchange for the energy-backed tokens 306a-306m.

For instance, a household with surplus solar energy may tokenize the excess energy into the one or more energy-backed tokens 306a-306m and vend them to an industrial entity 304n through a smart contract executed on the decentralized network 300. The transaction may be validated by the energy management system 302 to enable accurate reconciliation and token issuance based on the energy-related transaction of the excess energy.

According to another scenario of the present invention, the decentralized network 300 may be configured to integrate with financial institutions to enable tokenized energy trading through the decentralized finance (DeFi) currency 308. For example, an entity 304b may stake the energy-backed tokens 306a-306m that may be owned by the entity 304b in a liquidity pool to allow other participants to borrow some or all of the energy-backed tokens 306a-306m against collateral. The smart contract governing the lending process may be configured to automatically enforce interest rates and repayment terms based on real-time energy prices and market conditions.

According to yet another scenario of the present invention, the decentralized network 300 may configured to implement a carbon credit trading mechanism, in which some or all of the energy-backed tokens 306a-306m may be linked to carbon offsets. The one or more entities 304a-304n may trade and/or redeem the some or all of the energy-backed tokens 306a-306m. The reserve manager (i.e., the reserve manager 222) may be configured to maintain the liquidity by managing the currency reserves for redemptions corresponding to the one or more orchestrated energy-backed tokens 306a-306m. The currency reserves may be, fiat reserves, cryptocurrency reserves, and so forth.

According to at least one embodiment of the present invention, the decentralized network 300 may employ artificial intelligence (AI) algorithms within the energy management system 302 to predict energy demand and optimize distribution of the energy-backed tokens 306a-306m. The artificial intelligence (AI) algorithms may be configured to assess historical energy usage patterns, weather conditions, and grid stability to recommend optimal token trading strategies for the one or more entities 304a-304n. Furthermore, the decentralized network 300 may incorporate multi-signature authentication and encryption mechanisms to enhance security in energy trading. The decentralized network 300 may further incorporate authentication mechanisms to validate the energy trading before executing smart contracts for protection against fraudulent activities and/or unauthorized access.

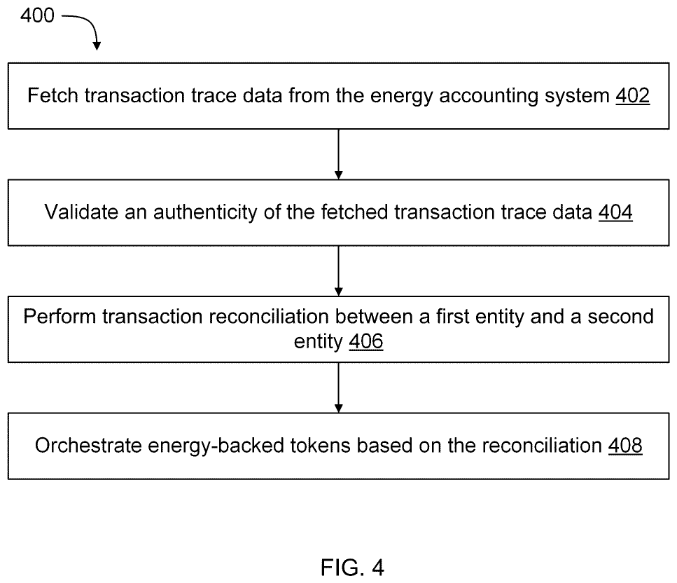

FIGS. 4-7 may present illustrative one or more processes 400-700 for implementing systems for managing the energies, in accordance with at least one embodiment of the present invention. It is to be understood that the processes 400-700, as illustrated in the FIGS. 4-7, may be described in accordance with at least one embodiment of the present invention without direct reference to specific numerals of the components depicted corresponding to the energy management systems 112 (FIG. 1) or 200 (FIG. 2) or 302 (FIG. 3). The omission of specific numerals for components in describing the processes 400-700 may not limit the scope of the invention, and the processes 400-700 may be implemented using any suitable configuration or arrangement of the components described in the energy management systems 112 (FIG. 1) or 200 (FIG. 2) or 302 (FIG. 3).

The one or more processes 400-700 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any number of the described blocks may be combined in any suitable order and/or in parallel to implement the process.

FIG. 4 is a process 400 of token orchestration in accordance with at least one embodiment of the present invention.

At block 402, the tokenization platform of the energy management system may be configured to fetch the transaction trace data from the energy accounting system. The transaction trace data may be stored in the transaction datastore of the energy accounting system.

At block 404, the tokenization platform may be configured to validate an authenticity of the fetched transaction trace data. The tokenization platform may be configured to validate the fetched transaction trace data cross-referencing the fetched transaction trace data with logged records and/or historical trends to ensure there are no discrepancies or errors. Additionally, the tokenization platform may be configured to verify that the transaction trace data may be aligned with predefined regulatory standards, contractual terms, and/or market conditions.

At block 406, the tokenization platform may be configured to perform the transaction reconciliation between a first entity and a second entity using the transaction monitor. At an instance, the first entity may be an energy producer, such as ‘Entity G’, which has surplus energy available for trade. The second entity, such as ‘Entity H’, may be an energy consumer and/or another trading entity that may be intended to purchase and/or receive the surplus energy. The transaction reconciliation process may be configured to include a validation that the agreed-upon terms of the transaction are met. The tokenization platform may also check for any discrepancies or issues in the transaction trace data, such as conflicting energy consumption or generation records, and resolve these issues through reconciliation protocols.

At block 408, the tokenization platform may be configured to orchestrate the energy-backed tokens based on the transaction reconciliation between the first entity and the second entity. The orchestration of the energy-backed tokens may involve the minting of the energy-backed tokens for the energy traded between the entities. In an embodiment of the present invention, the some or all of the energy-backed tokens may be configured to represent a fractional unit of the energy. The minted energy-backed tokens may be assigned to an appropriate entity based on an outcome of the reconciliation process. For example, the energy-backed token may be debited to an ‘Entity I’ as a reflection of the energy received, while an ‘Entity J’ may have the corresponding energy-backed tokens credited to reflect the energy transfer. Furthermore, the orchestration process may also involve the burning of the energy-backed tokens to reflect the energy debits in the energy management system.

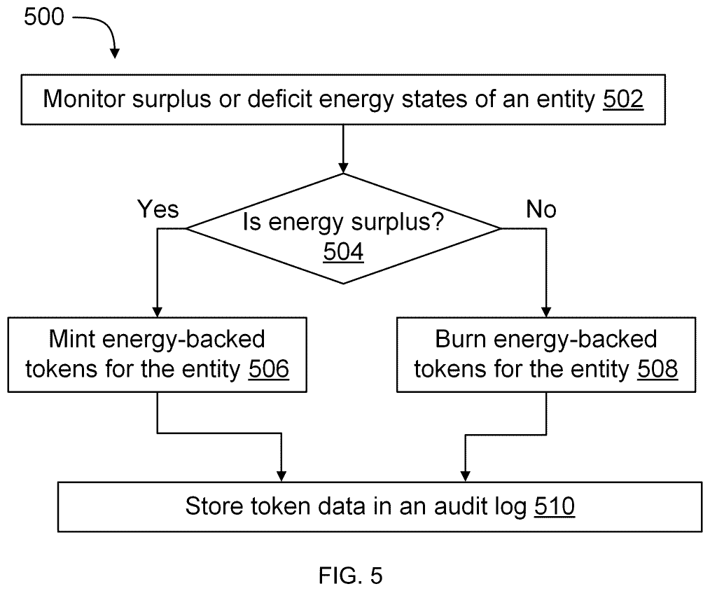

FIG. 5 is a process 500 of token life-cycle management in accordance with at least one embodiment of the present invention.

At block 502, the energy management system may be configured to monitor the surplus and/or deficit energy states of an entity using the token manager. The energy management system may be configured to continuously track the energy generation and energy consumption by the entity. The energy management system may further be configured to determine whether the entity has the surplus energy that may be traded or if the entity may be facing a deficit energy state that may require energy acquisition. This real-time monitoring may enable effective management of energy-related transactions and/or issuance of the energy-backed tokens.

At block 504, the energy management system may be configured to determine if the entity has generated the surplus energy. Upon determining the surplus energy of the entity, the energy management system may be configured to proceed to a 506 block. Further, if no surplus energy may be detected, the energy management system may be configured to proceed to block 508 to handle the deficit energy state.

At block 506, the energy management system may be configured to mint the energy-backed tokens for the entity. The minted energy-backed tokens may be configured to represent a proportional amount of the surplus energy generated by the entity and may be assigned a corresponding value based on the energy amount and other factors such as market conditions.

At the block 508, the energy management system may be configured to burn the energy-backed tokens for the entity. The burning of the energy-backed tokens may be configured to represent the consumption and/or withdrawal of the energy credits from the entity.

Further, at block 510, the energy management system may be configured to store the token-data corresponding to the minting and/or burning of the energy-backed tokens for the entity in the audit log. The audit log may be configured to as a secure and/or transparent record of all token-related actions such that every minting and burning event may be traceable and verifiable within the energy management system.

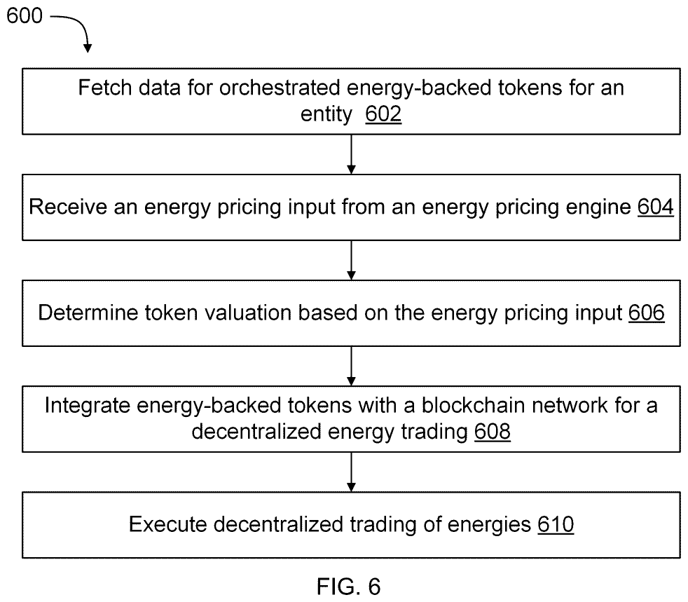

FIG. 6 is a process 600 of decentralized trading of energies in accordance with at least one embodiment of the present invention.

At block 602, the energy management system may be configured to fetch data for the one or more orchestrated energy-backed tokens for an entity.

At block 604, the energy management system may be configured to receive the pricing input corresponding to the one or more orchestrated energy-backed tokens from the energy pricing engine.

At block 606, the energy management system may be configured to determine a token valuation based on the energy pricing input. Using the pricing input received from the energy pricing engine, the energy management system may be configured to calculate the market value of the one or more orchestrated energy-backed tokens. This calculation may factor in market dynamics such as energy demand fluctuations, energy supply levels, and other economic conditions to ensure the valuation reflects the true market value of the energy represented by the tokens.

At block 608, the energy management system may be configured to integrate the one or more orchestrated energy-backed tokens with the blockchain network for decentralized energy trading. By employing the blockchain network, the energy management system may be configured to securely store and/or transact the energy-backed tokens in a decentralized manner.

At block 610, the energy management system may be configured to execute the decentralized trading of energies. Based on the token valuation, the energy management system may be configured to facilitate the execution of energy transactions between the one or more entities in a decentralized manner. The energy management system may be configured to enable the one or more entities to exchange the energy-backed tokens without relying on centralized intermediaries to enhance a market participation.

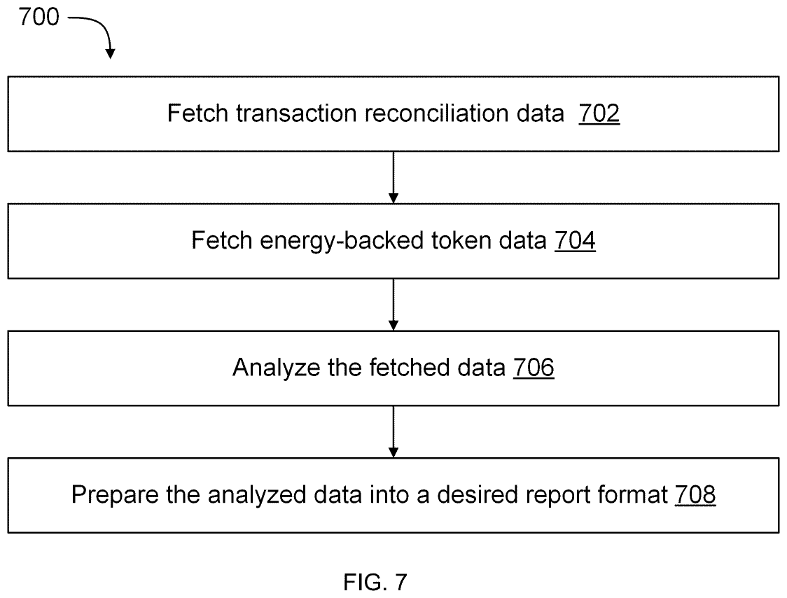

FIG. 7 is an process 700 of report generation in accordance with at least one embodiment of the present invention.

At block 702, the energy management system may be configured to monitor the surplus and/or deficit energy states of an entity using the token manager. The token manager may be configured to track the energy generation and/or the energy consumption of the entity. Based on the tracked energy generation and/or the energy consumption of the entity, the token manager may be configured to identify whether the entity has the surplus energy or may be experiencing the deficit energy state.

At block 704, the energy management system may be configured to fetch the token data corresponding to the minting and/or the burning of the energy-backed tokens for the entity in the audit log.

At block 706, the energy management system may be configured to analyze the fetched token data. For instance, the analysis of the fetched token data may involve reviewing the minting and burning events of the energy-backed tokens.

At block 708, the energy management system may be configured to prepare the analyzed data into the desired report format.

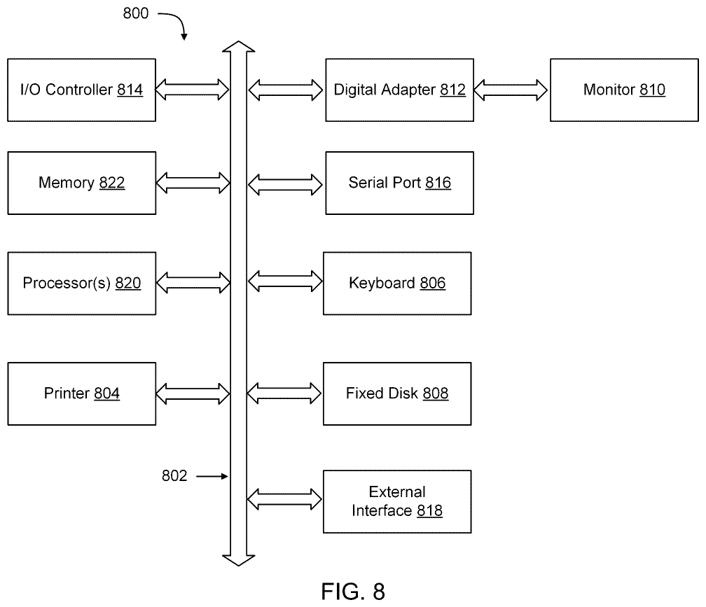

FIG. 8 depicts a schematic diagram illustrating aspects of an example computer in accordance with at least one embodiment of the present invention. In accordance with at least some embodiments of the present invention, the system, apparatus, methods, processes and/or operations for message coding may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system.

As an example, FIG. 8 depicts aspects of elements that may be present in a computer device and/or system 800 configured to implement a method and/or process in accordance with some embodiments of the present invention. The subsystems shown in FIG. 8 are interconnected via a system bus 802. Additional subsystems such as a printer 804, a keyboard 806, a fixed disk 808, a monitor 810, which is coupled to a display adapter 812. Peripherals and input/output (I/O) devices, which couple to an I/O controller 814, may be connected to the computer system by any number of means known in the art, such as a serial port 816. For example, the serial port 816 or an external interface 818 may be utilized to connect the computer device 800 to further devices and/or systems not shown in the FIG. 8 including a wide area network such as the Internet, a mouse input device, and/or a scanner. The interconnection via the system bus 802 may allow one or more processors 820 to communicate with each subsystem and to control the execution of instructions that may be stored in a system memory 822 and/or the fixed disk 808, as well as the exchange of information between subsystems. The system memory 822 and/or the fixed disk 808 may embody a tangible computer-readable medium.

It should be understood that the present invention as described above may be implemented in the form of control logic using computer software in a modular or integrated manner. Alternatively, or in addition, embodiments of the present invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of any and all examples, or exemplary language (e.g., “such as”) provided herein, is intended merely to better illuminate embodiments of the present invention and does not pose a limitation to the scope of the present invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the present invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An energy management system, comprising:
a tokenization platform communicatively coupled with at least one energy accounting system, comprising:
at least one transaction monitor configured to, at least:
fetch transaction trace data, from the at least one energy accounting system, for executing at least one energy-related transaction between at least one first entity and at least one second entity; and
perform transaction reconciliation for the at least one first entity and the at least one second entity based on the fetched transaction trace data; and
at least one token manager configured at least to orchestrate one or more energy-backed tokens based on the transaction reconciliation for the at least one first entity and the at least one second entity.

2. The energy management system of claim 1, wherein the tokenization platform further comprises at least one reserve manager configured to maintain a liquidity by managing currency reserves for redemptions corresponding to the one or more orchestrated energy-backed tokens.

3. The energy management system of claim 1, wherein the token manager is further configured to issue, burn, or mint the one or more energy-backed tokens based at least in part on a surplus energy state or a deficit energy state of the at least one first entity or the at least one second entity.

4. The energy management system of claim 1, wherein the token manager is further configured to integrate with at least one blockchain network to enable decentralized energy trading of energies by utilizing the one or more orchestrated energy-backed tokens.

5. The energy management system of claim 1, further comprising at least one transaction datastore configured to store the fetched transaction trace data.

6. The energy management system of claim 1, further comprising at least one reporting engine configured to generate at least one report based on the transaction reconciliations.

7. The energy management system of claim 1, further comprising at least one energy pricing engine configured to deliver at least one pricing input to the token manager for setting a price of the one or more orchestrated energy-backed tokens.

8. The energy management system of claim 1, wherein the tokenization platform is configured to at least enable tracking of the one or more orchestrated energy-backed tokens through at least one user device.

9. The energy management system of claim 1, wherein the at least one transaction monitor is configured to authenticate of the transaction trace data.

10. The energy management system of claim 1, wherein the at least one energy accounting system is configured to receive a reconciliation input from the at least one transaction monitor upon the transaction reconciliation.

11. A method for tokenized energy management comprising:
fetching transaction trace data from at least one energy accounting system for executing at least one energy-related transaction between at least one first entity and at least one second entity;
performing transaction reconciliation for the at least one first entity and the at least one second entity based on the fetched transaction trace data; and
orchestrating one or more energy-backed tokens for the at least one first entity and the at least one second entity based on the transaction reconciliation.

12. The method of claim 11, further comprising issuing, burning, or minting the one or more energy-backed tokens based at least in part on a surplus energy state or a deficit energy state of the at least one first entity or the at least one second entity.

13. The method of claim 11, further comprising maintaining liquidity for the one or more orchestrated energy-backed tokens by managing currency reserves corresponding to the energy-related transactions in at least one reserve manager.

14. The method of claim 11, further comprising integrating with at least one blockchain network to enable decentralized trading of energy utilizing the one or more orchestrated energy-backed tokens.

15. The method of claim 11, further comprising storing the fetched transaction trace data and reconciliation results in at least one transaction datastore.

16. The method of claim 11, further comprising generating reports based on the transaction reconciliations using at least one reporting engine.

17. The method of claim 11, further comprising determining valuation of the one or more orchestrated energy-backed tokens by analyzing energy pricing using at least one energy pricing engine.

18. The method of claim 11, further comprising enabling at least one energy management system user to track the one or more orchestrated energy-backed tokens through at least one user device.

19. One or more computer-readable media, collectively storing instructions that, when executed by one or more processors, collectively cause one or more computing devices to, at least:
fetch transaction trace data from at least one energy accounting system for executing at least one energy-related transaction between at least one first entity and at least one second entity;
perform transaction reconciliation for the at least one first entity and the at least one second entity based on the fetched transaction trace data; and
orchestrate one or more energy-backed tokens for the at least one first entity and the at least one second entity based on the transaction reconciliation.

20. The one or more computer-readable media of claim 19, wherein the instructions further cause the computing device to determine valuation of the one or more orchestrated energy-backed tokens by analyzing energy pricing dynamics using at least one energy pricing engine.
